(19) United States
(12) Patent Application Publication
(10) Pub. No.: US 2011/0043433 A1
(43) Pub. Date: Feb. 24, 2011

(54) Positioning equipment for aligning a device

(75) Inventor: Stefan Klien, Hohenems (AT)

Correspondence Address: VOLPE AND KOENIG, P.C., UNITED PLAZA, 30 SOUTH 17TH STREET, PHILADELPHIA, PA, 19103, US

(73) Assignee: Jurgen Zimmermann, Bregenz (AT)

(21) Appl. No.: 12/583,631

(22) Filed: Aug. 24, 2009

(51) Int. Cl. H01Q 3/02; G02B 7/182

(52) U.S. Cl. 343/882; 359/872

(57) ABSTRACT

An adjustment device for aligning a unit (1), which receives and/or transmits and/or focuses radiation, including a support (4) for positioning the adjustment device upon a foundation, a pivotal unit (3), which in reference to the support (4) can be rotated around a horizontal lower axis (6), and the unit (1) to be aligned can be rotated in reference thereto around an upper axis (7) positioned perpendicular in reference to the lower axis (6), and which upper axis is positioned horizontally in reference to a neutral position of the pivotal unit (3) in reference to a rotation of the pivotal unit (3) around the lower axis (6), a lower actuator drive (8) for rotating the pivotal unit (3) in reference to the support (4) around the lower axis (6), and an upper actuator drive (11) for rotating the unit (1) to be aligned around the upper axis (7) in reference to the pivotal unit (3), with the pivotal unit (3) comprising a base section (14) and at least one upper bearing section (15, 16), projecting upwards therefrom in the neutral position of the pivotal unit (3) in reference to the rotation of the pivotal unit (3) around the lower axis (6), with the unit (1) to be aligned being supported pivotally around the upper axis (7) at the upper bearing section and further including at least one lower bearing section (18, 19) projecting downwards from a base section (14) in the neutral position of the pivotal unit (3) in reference to the rotation of the pivotal unit (3) around the lower axis (6), with the pivotal unit (3) being supported at the lower bearing section, pivotally around the lower axis (6) in reference to the support (4).

### BACKGROUND

The invention relates to an adjustment device for aligning a unit which receives and/or transmits and/or focuses radiation, comprising a support for positioning the adjustment device upon a foundation, a pivotal unit, which can be rotated around a horizontal lower axis in reference to the support, and said unit to be aligned can be rotated in reference thereto around an upper axis positioned perpendicular in reference to said lower axis, and which upper axis is positioned horizontally in reference to a neutral position of the pivotal unit in reference to a rotation of the pivotal unit around the lower axis, a lower actuator drive for rotating the pivotal unit around the lower axis in reference to the support, and an upper actuator drive for rotating the unit to be aligned around the upper axis in reference to the pivotal unit, with the pivotal unit comprising a base section and at least one upper bearing section, projecting upwards in the neutral position of the pivotal unit in reference to the rotation of the pivotal unit around the lower axis, at which the unit to be aligned is supported pivotally around the upper axis.

Parabolic mirrors are used, for example in parabolic antennas, to concentrate microwave radiation at the focal point of the parabolic mirror. Here, the radiation is collected by a detector or reflected by a reflector to a detector, for example a projector, through an opening in the parabolic mirror.

In order to communicate with near-earth satellites parabolic mirrors are used having diameters of 10 m or more. Large parabolic antennas with diameters of up to 100 m are found in ground controls for monitoring and controlling interplanetary space crafts, radio telescopes, and radar devices for extra-terrestrial applications.

A conventional embodiment of a parabolic antenna comprises a parabolic mirror in the form of a rotation-symmetrical formation (paraboloid) with its cross-section representing a parabola. The exciter (receiver or transmitter part) is located in the focal point of the paraboloid on the rotational axis (no offset) or outside the rotational axis (offset.) The design without any offset is particularly used for large antennas. Cassegrain-antennas represent another embodiment of a conventional parabolic antenna, in which a sub-reflector is used instead of the exciter. The exciter is then usually arranged in a hole in the center of the parabolic area. The so-called Gregory-antennas represent another embodiment with a sub-reflector.

In a known tracking system and/or adjustment device for aligning a parabolic antenna said parabolic antenna is connected to a pivotal unit, swiveling around a horizontal axis (elevation axis), which pivotal unit in turn is arranged on a base, pivotal around a vertical axis (Azimuth axis) using a rotating assembly. Here, the production expenses are relatively high. Instead of the embodiment using a rotating assembly it is also known to use a linear drive for pivoting around the Azimuth axis. Accordingly the pivotal axis is limited, here.

Further, solar tracking devices for photovoltaic arrangements are known in various embodiments. In a common embodiment a support frame carrying the solar cells is pivotal, on the one side around a vertical axis (Azimuth axis), on the other side around a horizontal axis (elevation axis.) In order to form the vertical axis rotational assemblies are used, which are provided with teeth, for example, cooperating with a rotational actuator.

Further, a tracking device has become known for adjusting the alignment of a support frame for solar cell modules, in which the pivotal unit comprises a beam-shaped carrier, which in reference to a support is pivotal around a lower horizontal axis, which is aligned in the east-west direction. The beam-shaped carrier has a multitude of straps at a distance along the carrier and projecting upwards, by which the carriers of the support frame are connected pivotally around an upper axis. The lower and the upper axis are aligned perpendicularly in reference to each other. In a neutral position of the pivotal unit in reference to a rotation around the lower axis the carrier forming the pivotal unit is located horizontally and accordingly so is the upper axis. The Azimuth and the elevation are adjusted by a combination of rotations around the two axes, with separate actuators being provided, which are formed by spindle drives. A disadvantage of this arrangement is caused by the limited pivotal range of the carrier forming the pivotal unit around the lower axis. The pivoting range of the support frame around the upper axis is also limited. This therefore restricts the tracking range.

Solar tracking devices for photovoltaic arrangements are discernible, for example, from WO 93/13396 and US 2007/0215199 Al.

### SUMMARY

The object of the invention is to provide a device of the type mentioned at the outset, in which a large range of settings is allowed using a simple construction.

This is attained according to the invention by an adjustment device for aligning a unit receiving and/or transmitting and/or focusing radiation, comprising a support for positioning the adjustment device upon a foundation, a pivotal unit, which in reference to the support can be rotated around a horizontal lower axis, and said unit to be aligned can be rotated in reference thereto around an upper axis positioned perpendicular in reference to said lower axis, and which upper axis is positioned horizontally in reference to a neutral position of the pivotal unit in reference to a rotation of the pivotal unit around the lower axis, a lower actuator drive for rotating the pivotal unit in reference to the support around the lower axis, and an upper actuator drive for pivoting the unit to be aligned around the upper axis in reference to the pivotal unit, with the pivotal unit comprising a base section and at least one upper bearing section, projecting upwards therefrom in the neutral position of the pivotal unit in reference to the rotation of the pivotal unit around the lower axis, on which upper bearing section the unit to be aligned is supported pivotally around the upper axis, and further comprises at least one lower bearing section, projecting downward from the base section in the neutral position of the pivotal unit in reference to the rotation of the pivotal unit around the lower axis, at which lower bearing section the pivotal unit is supported rotating around the lower axis in reference to the support.

By the embodiment of the pivotal unit with, in reference to the neutral position of the rotation around the lower axis, at least one upper bearing section projecting upwards from an upper base section, on which upper bearing section the unit to be aligned is supported pivotally around the upper axis, as well as at least one lower bearing section projecting downwards from a lower base section, at which lower bearing section the pivotal unit is supported pivotally around the lower axis in reference to the support, a potentially large pivoting range around the lower axis can be achieved. Beginning from a neutral position of the pivotal unit, preferably the pivoting range around the lower axis amounts to at least 70°, and particularly preferred to at least 90° in both pivotal directions.

In an advantageous embodiment of the invention, the unit to be aligned is pivotal around the upper axis by at least 60°, with a value of at least 80° being particularly preferred. Here, beneficially at least one upper bearing section projects diagonally upwards from the base section of the pivotal unit.

For reasons of stability it is advantageous when at least two lower bearing sections are provided, by which at least two separate pivot bearings are formed, spaced apart in reference to each other in the direction of the lower axis. In order to achieve a pivotal angle as large as possible around the upper axis, here preferably a plane is arranged laterally next to at least two lower bearing sections, including the upper axis and positioned perpendicularly in reference to the lower axis, (i.e. not in the area between the two lower bearing sections and/or in the event more than two lower bearing sections are provided not in the area between the two outer lower bearing sections).

Further, for reasons of stability it is advantageous when at least two upper bearing sections are provided, by which at least two separate pivot bearings are formed, spaced apart in reference to each other in the direction of the upper axis.

In an advantageous embodiment of the invention, the upper actuator drive engages, on the one side, the unit to be aligned, with said actuator drive being linked to the unit to be aligned, and on the other side, an arm of the pivotal unit or at least one bearing part connected thereto in a fixed manner. Here, the arm projects horizontally or at least essentially horizontally from the area of the base sections of the pivotal unit, from which at least one upper bearing section and at least one lower bearing section extend, i.e. at an angle ranging from +/−30° in reference to the horizontal. The upper actuator drive is here directly linked to the arm, preferably in the area of its free end, or at least to one bearing part, connected to the arm in a fixed manner, preferably in the area of its free end. Here, with a simple arrangement, a large adjustable pivoting angle around the upper axis can be achieved by the upper actuator drive.

In an advantageous embodiment of the invention, the unit to be aligned can be provided with a parabolic mirror or be formed by a parabolic mirror.

A device according to the invention with a parabolic mirror that can be aligned may represent an antenna for receiving and/or transmitting electromagnetic waves. For example, such an antenna may form a directional antenna (for a radio relay), a radar antenna, a satellite antenna, a WLA-antenna, or another antenna. A device according to the invention with a parabolic mirror that can be aligned may also form a sun and/or solar mirror for receiving solar radiation and/or absorbing solar energy. For example, an evaporator may be arranged in the focal point of such a solar mirror in order to form a thermal power plant. Such solar mirrors are also called solar antennas. Further, a device according to the invention may also form a part of a thermal power plant, with several solar mirrors being used, embodied as parabolic mirrors focused on the same point.

If the parabolic mirror is to be aligned to the position of the sun, preferably the lower axis is aligned in the north-south direction and the upper axis is aligned in the east-west direction in the neutral position of the pivotal unit with regard to the rotation around the lower axis.

In another advantageous embodiment of the invention the unit to be aligned may comprise a support frame or may be formed by a support frame carrying elements which are to be aligned in reference to the position of the sun. Preferably the support frame forms a device plane, here, abutted by the carried elements. For example, the carried elements may represent solar cell-modules of a photovoltaic arrangement.

In the following, additional advantages and details of the invention are explained using the drawing.

### BRIEF DESCRIPTION OF THE DRAWINGS

The drawings show:

FIG. 1 a perspective view of an exemplary embodiment of a device according to the invention, with neutral positions being taken with regard to the rotation around the lower axis and the upper axis (=“neutral position”);

FIG. 2 a perspective view of the device of FIG. 1 in a position rotated in reference thereto;

FIG. 3 a side view of the device in the direction of view A in FIG. 7, in a position according to FIG. 1;

FIGS. 4 and 5 side views according to FIG. 3 in positions rotated maximally around the lower axis in both pivotal directions in reference to the normal position;

FIG. 6 a perspective view of another position pivoted around the lower axis in reference to the normal position (in a range between the neutral position and the maximally rotated position);

FIG. 7 a side view in the normal position in the direction of view B in FIG. 3;

FIG. 8 a side view according to FIG. 7, but in a position rotated around the upper axis in reference to the normal position (in a central position between the normal position and the maximally rotated position);

FIG. 9 a side view according to FIG. 8, but in a status maximally rotated around the upper axis;

FIG. 10 a perspective view of a device in another position rotated around the upper axis in reference to the normal position (in a position between the normal position and the maximally rotated position);

FIG. 11 an enlarged section from FIG. 10;

FIGS. 12 through 22 a second exemplary embodiment of a device according to the invention with views similar to FIGS. 1 through 11.

### DETAILED DESCRIPTION OF THE PREFERRED EMBODIMENTS

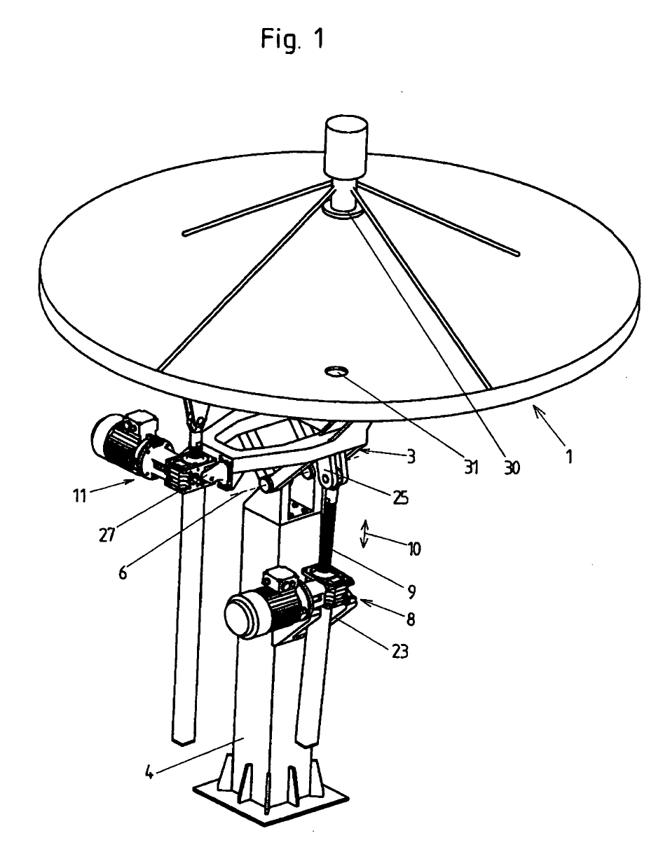

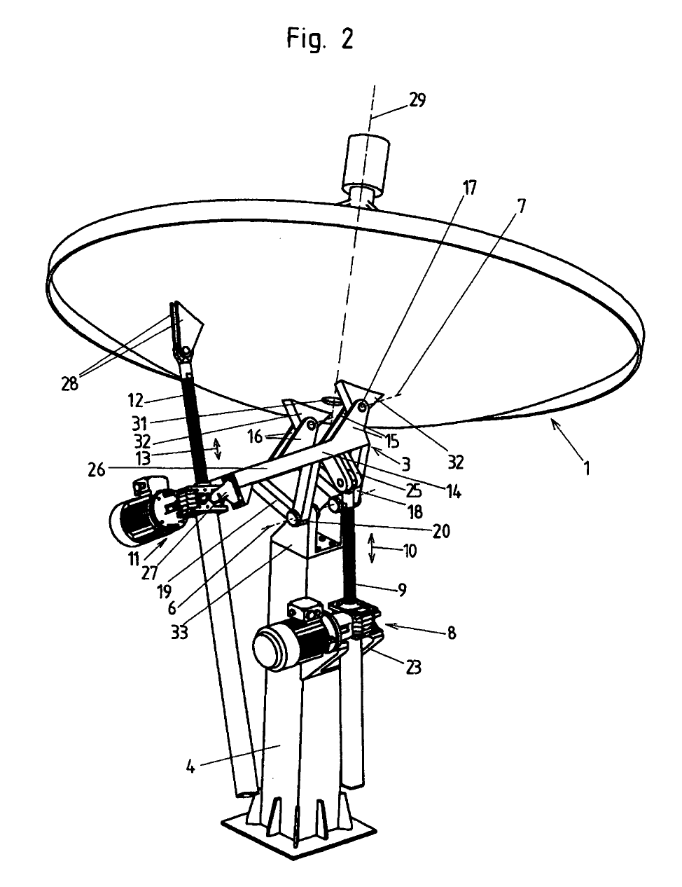

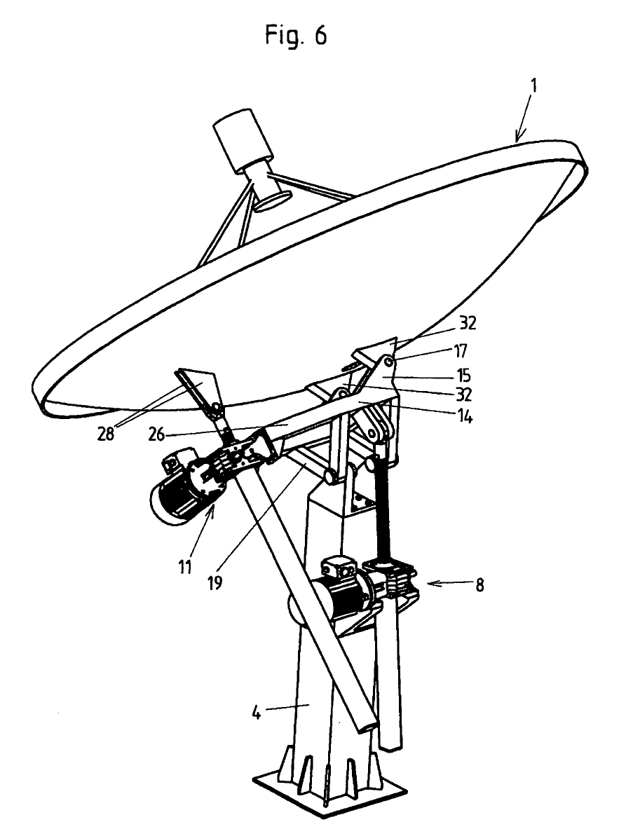

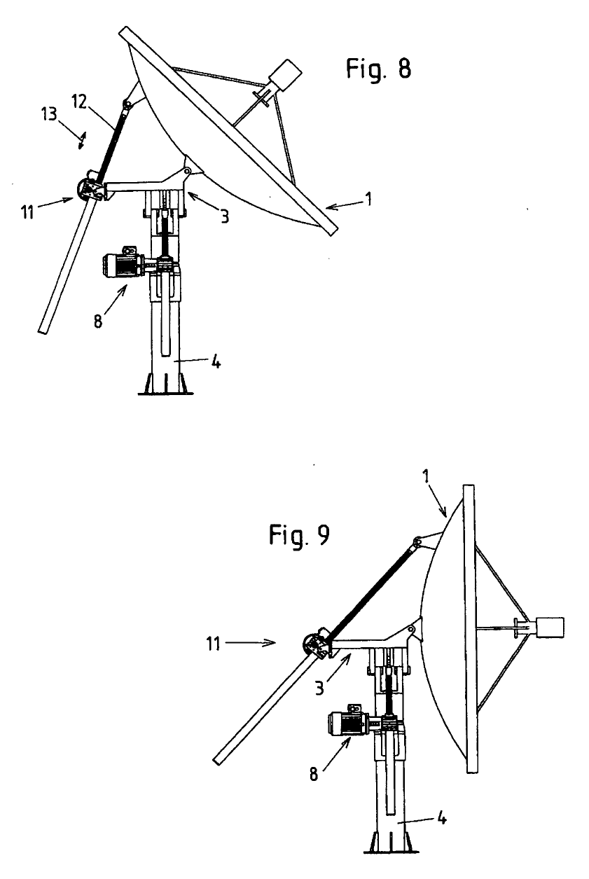

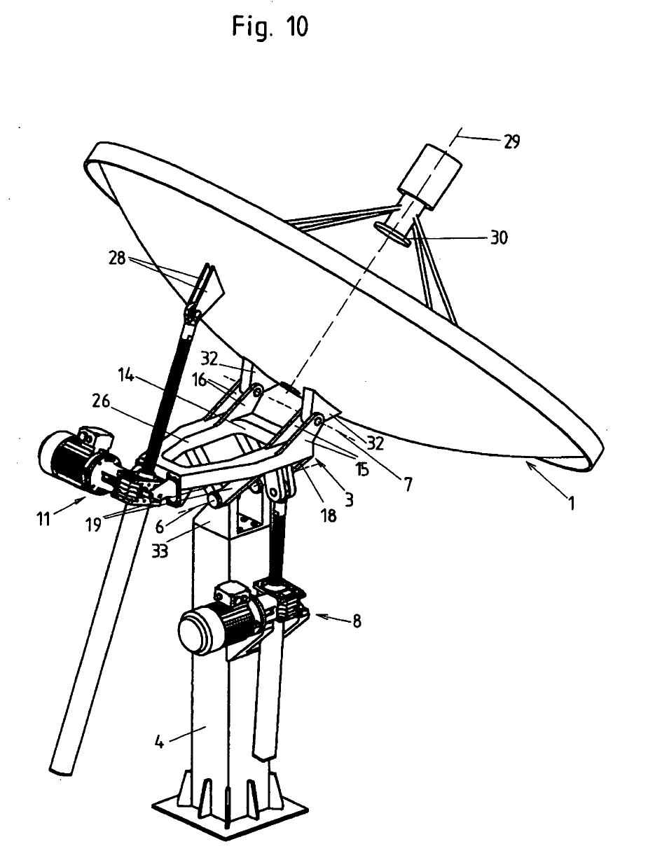

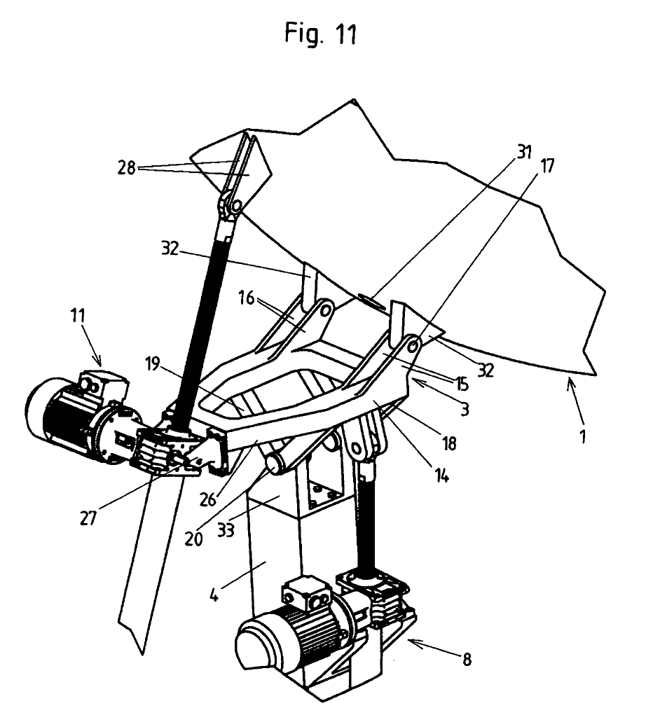

In the following, a first exemplary embodiment of a device according to the invention is explained using FIGS. 1 through 11. In this exemplary embodiment, the unit to be aligned comprises a parabolic mirror 1. Such parabolic mirrors 1 are used in various embodiments for receiving and/or transmitting and/or focusing radiation. In the embodiments shown the parabolic mirror 1 is a part of a parabolic antenna. Various embodiments of such parabolic antennas are known. Here, a reflector 30 is arranged in the focal point of the paraboloid, particularly in the form of an electromagnetic horn, which reflects the radiation to an opening 31 in the center of the parabolic mirror 1. The receiver and/or transmitter unit to be arranged at this place (depending on it representing a receiver or a transmitter antenna or a combination thereof) are not shown for reasons of simplification.

Instead of an embodiment in the form of the parabolic antennas shown, the invention may also be embodied as another unit having a parabolic antenna that can be aligned.

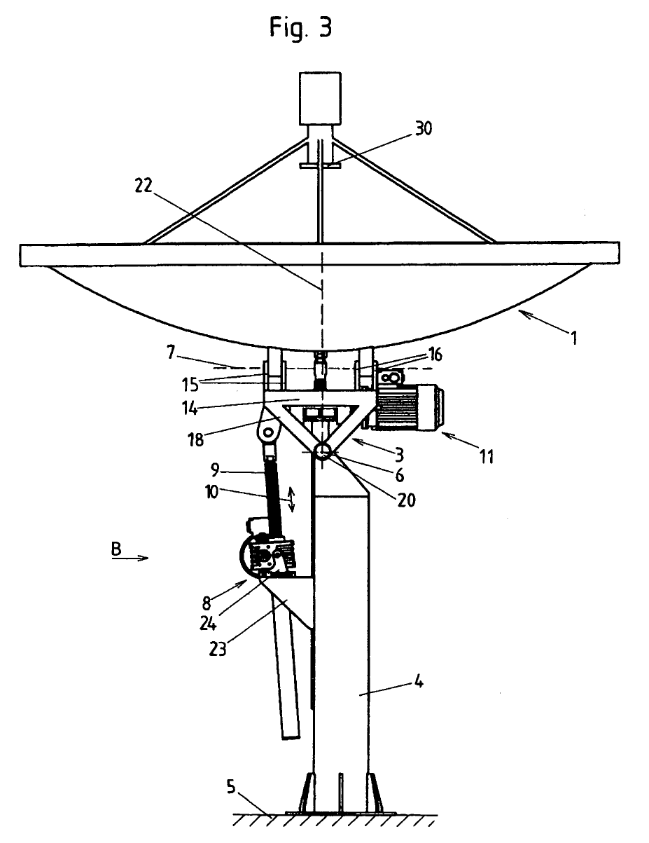

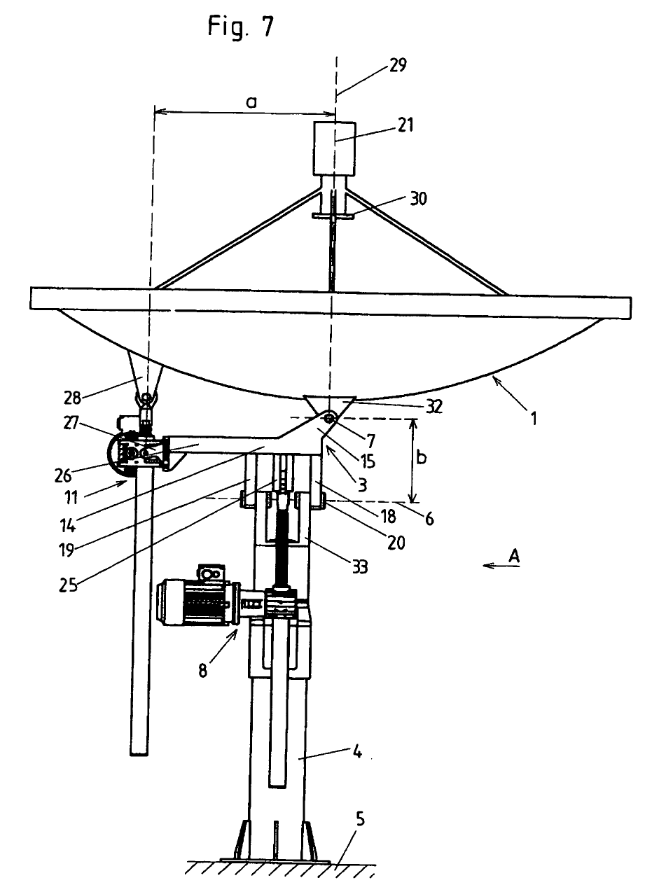

A pivotal unit 3 is connected in a rotary fashion, on the one side to the parabolic mirror 1, on the other side to a support 4, which is anchored fixed in reference to the foundation 5 (indicated in FIGS. 3 and 7.) Here, the support 4 is in the form of a tower stand. The pivotal unit 3 is rotational in reference to the support 4 around a horizontal lower axis 6, and the parabolic mirror 1 is pivotal around an upper axis 7 in reference to the pivotal unit 3, which is positioned at a right angle in reference to the lower axis 6. In the rotated position of the pivotal unit 3 with regard to the rotation around the lower axis 6 shown in FIGS. 1, 3, and 7, the upper axis 7 is positioned horizontally. This rotated position of the pivotal unit 3 in reference to the lower axis 6, in which the upper axis 7 is positioned horizontally, is called the “normal position” in the present document with regard to the rotation around the lower axis 6.

The axis 29 of the parabolic mirror is positioned vertically, when in the neutral position of the pivotal unit 3 in reference to the rotation around the lower axis 6 the parabolic mirror 1 takes the pivotal position around the upper axis 7 shown in FIGS. 1, 3, and 10. The rotated position of the parabolic mirror 1 around the upper axis 7 taken here is called the “neutral position” in the present paper with regard to the rotation around the upper axis 7. When both the neutral position with respect to the rotation around the lower axis 6 as well as the neutral position with respect to the rotation around the upper axis 7 are taken, this position is called the “zero position” in the present paper. The zero position is shown in FIGS. 1, 3, and 7.

A lower actuator drive 8 serves to adjust the pivotal angle of the pivotal unit 3 around the lower axis 6. It is provided with an operating element 9 that is adjustable both ways in a straight-line adjustment direction 10. For example, the actuator drive 8 is embodied in the form of a spindle drive (such spindle drives are sometimes also called spindle-type lifting gears).

An upper actuator drive 11 serves to adjust the pivoting angle of the parabolic mirror 1 around the upper axis 7. This actuator drive comprises an operating element 12 adjustable both ways in an adjustment direction 13. For example, the upper actuating drive 11 is embodied as a spindle-type lifting gear.

The pivotal unit 3 comprises a base section 14. Two upper bearing sections 15, 16 project upwards from the base section 14 in reference to the normal position with regard to the rotation around the lower axis 6, where they preferably project diagonally upwards as shown. These upper bearing sections 15, 16 serve (in the area of their upper ends) to form pivot bearings for the parabolic mirror 1.

In the exemplary embodiment shown a respectively upper bearing section 15, 16 is formed by two parallel straps, between which a bearing stud 17 extends pivotally supporting the parabolic mirror 1. Other embodiments of the upper bearing sections 15, 16 can be imagined and are possible, for example in the form of bearing blocks with struts positioned at an angle in reference to each other. For reasons of stability, it is preferred that at least two upper bearing sections 15, 16 are provided, by which at least two separate pivot bearings are formed at a distance from each other in the direction of the upper axis 7. It is also possible for more than two such upper bearing sections 15, 16 to be provided.

In the exemplary embodiment shown, the upper bearing sections 15, 16 are pivotally connected to bearing parts 32, which are mounted fixed to the parabolic mirror 1. The bearing parts 32 can be embodied, for example, in the form of support straps as shown or in the form of bearing blocks. A bearing part embodied as a single U-shaped part or formed in one piece with the parabolic mirror 1 are contemplated and possible as well.

Further, from the base section 14 two lower bearing sections 18, 19 project downwards in reference to the normal position of the rotation of the pivotal unit 3 around the lower axis 6. These bearing sections serve (in the area of their lower ends) to form pivot bearings for a pivotal support of the pivotal unit 3 in reference to the support 4.

In the exemplary embodiment shown, the lower bearing sections 18, 19 are each formed by a bearing block that is formed by two struts merging towards the bottom and connected to each other at their lower ends. In this manner, the bottom bearing sections 18, 19 are formed tapering towards the bottom. Other embodiments of such bearing sections tapering towards the bottom are contemplated and possible, for example via bearing lugs. Preferably the lower bearing sections 18, 19 are embodied triangularly with a tip pointing towards the bottom.

For reasons of stability it is preferred that at least two lower bearing sections 18, 19 are provided, by which at least two pivot bearings are formed, spaced apart from each other in the direction of the lower axis 6. It is also possible for more than two such lower bearing sections 18, 19 to be provided. The embodiment of the pivot bearings occurs via bearing studs 20.

In the exemplary embodiment shown, the lower bearing sections 18, 19 are pivotally connected to a bearing part 33, which is mounted fixed at the upper end of the stand of the support 4. The bearing part is here formed in a U-shaped manner comprising lateral bars, forming the link to the lower bearing sections 18, 19. Separate bearing parts for each of the bearing sections 18, 19 or a one-piece embodiment with the stand of the support 4 are also contemplated and possible.

The pivotal unit 3 can be embodied in one piece or in several parts connected to each other in a fixed manner.

In the exemplary embodiment shown, the plane 21 (cf. FIG. 7), in which the upper axis 7 is located and which is perpendicular in reference to the lower axis 6, is positioned laterally next to the two lower bearing sections 18, 19. This way, preferably a possibility for pivoting around the upper axis 7 up to the horizontal alignment of the axis 29 of the parabolic mirror 1 can be achieved, when the pivotal unit 3 is located at an arbitrary pivotal position in reference to the lower axis 6 (cf. FIG. 9.)

The plane 22, in which the lower axis 6 is located and which is positioned perpendicular in reference to the upper axis 7, is located between the two upper bearing sections 15, 16 (cf. FIG. 3.)

The lower actuator drive 8 engages, on the one side the support 4, namely via a console 23 mounted to the stand of the support 4, at which bearing blocks 24 are fastened, to which the lower actuator drive 8 is linked. On the other side the lower actuator drive 8 engages a connector piece 25, which in reference to the normal position of the pivotal unit 3 projects downwards from the base section 14 of the pivotal unit 3 with regard to a rotation around the lower axis 6. The lower actuator drive 8 is linked to this connector piece 25.

The upper actuator drive 11 is linked, on the one side to bearing parts 28 mounted fixed at the parabolic mirror 1, which here are formed by support straps or bearing blocks. An individual part embodied in a U-shaped manner or a one-piece embodiment of the bearing parts 28 with the parabolic mirror 1 are also contemplated and possible. On the other side, the upper actuator drive 11 is linked to bearing parts 27, which are mounted fixed to an arm 26 of the pivotal unit 3. The bearing parts 27 are here embodied in the form of bearing blocks. An individual bearing part, embodied in a U-shaped fashion, or an embodiment of a link to the arm 26 in one piece are also thinkable and possible. The arm 26 represents a horizontally or at least essentially horizontally projecting section of the base section 14 of the pivotal unit 3, here projecting from the section of the base section 14 where the upper bearing sections 15, 16, and the lower bearing sections 18, 19 originate. Here, the connecting point of the upper actuator 11 to the arm 26 and/or the bearing parts 27 mounted to the arm 26 shows a normal distance a from the plane 21, which amounts to at least half the normal distance b between the lower axis 6 and the upper axis 7, preferably to at least the entire normal distance b (cf. FIG. 7.)

The normal position, in which the axis 29 of the parabolic mirror 1 is positioned vertically, can be taken e.g., when larger wind forces impinge.

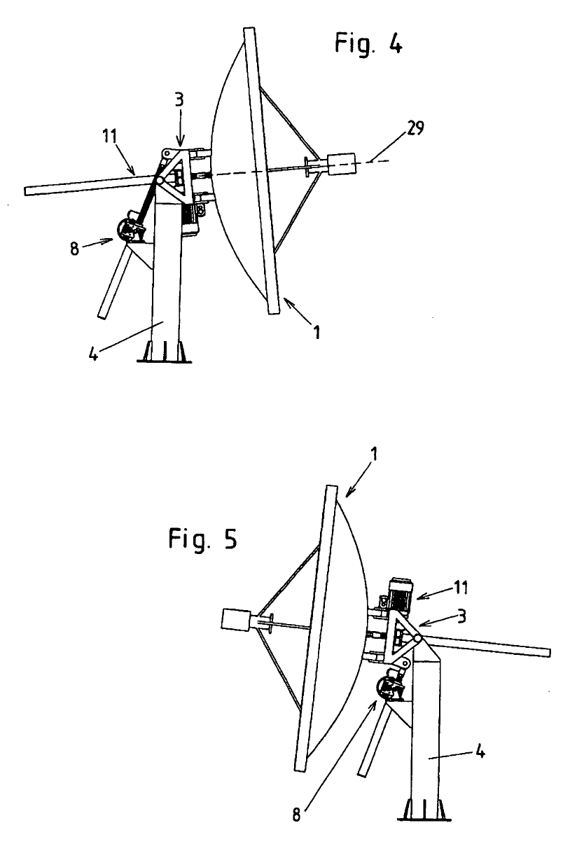

Beginning at the normal position with regard to the lower axis 6, the pivotal unit 3 can be rotated via the lower actuator drive 8 in both directions of rotation around the lower axis 6, preferably over an angular range up to at least 75° each (cf. FIGS. 4 and 5.) Based on the neutral position with regard to the upper axis 7, the parabolic mirror 1 can be rotated via the upper actuator drive 11 in a direction around the upper axis 7 over an angular range at least exceeding 60°, in the exemplary embodiment shown up to 90° (cf. FIG. 9.)

By the simultaneous rotation of the pivotal unit 3 around the lower axis 6 and the parabolic mirror 1 around the upper axis 7 the axis 29 of the parabolic mirror 1 can be aligned in a desired direction in space.

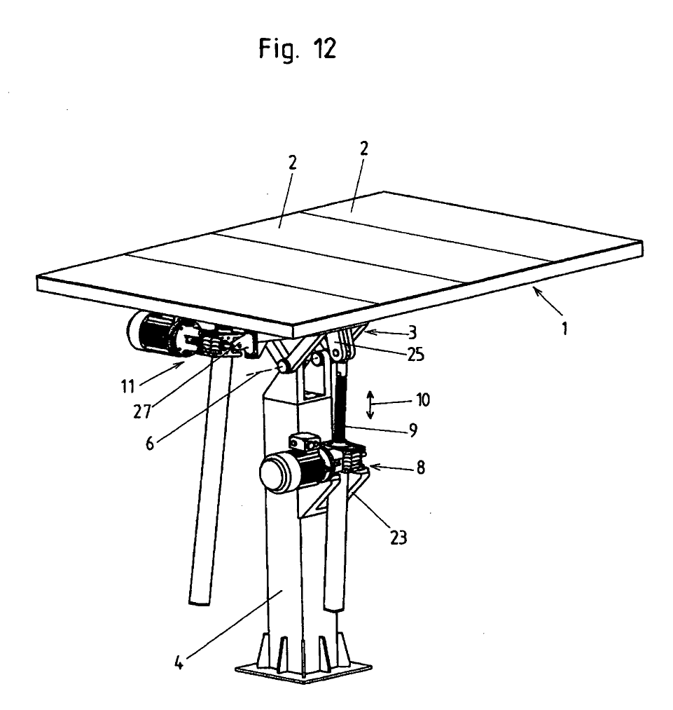

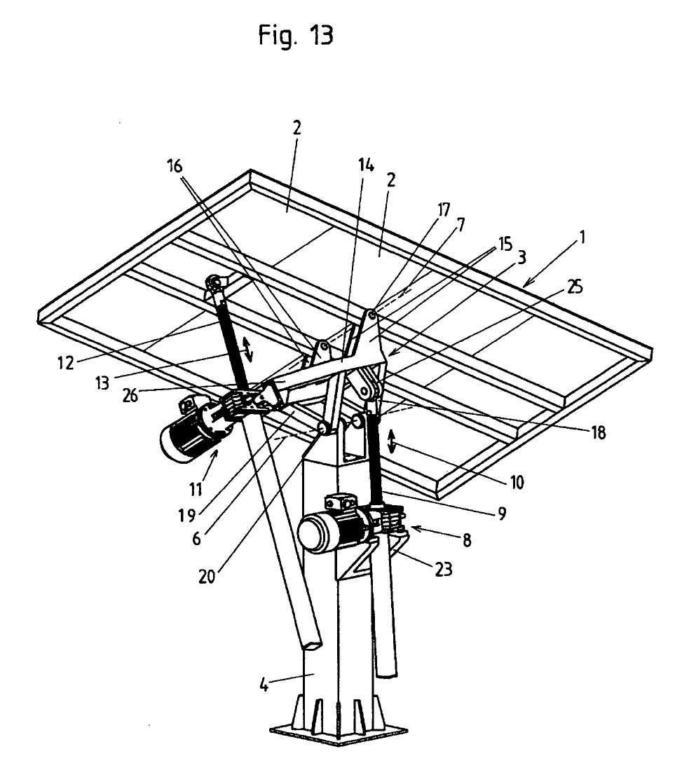

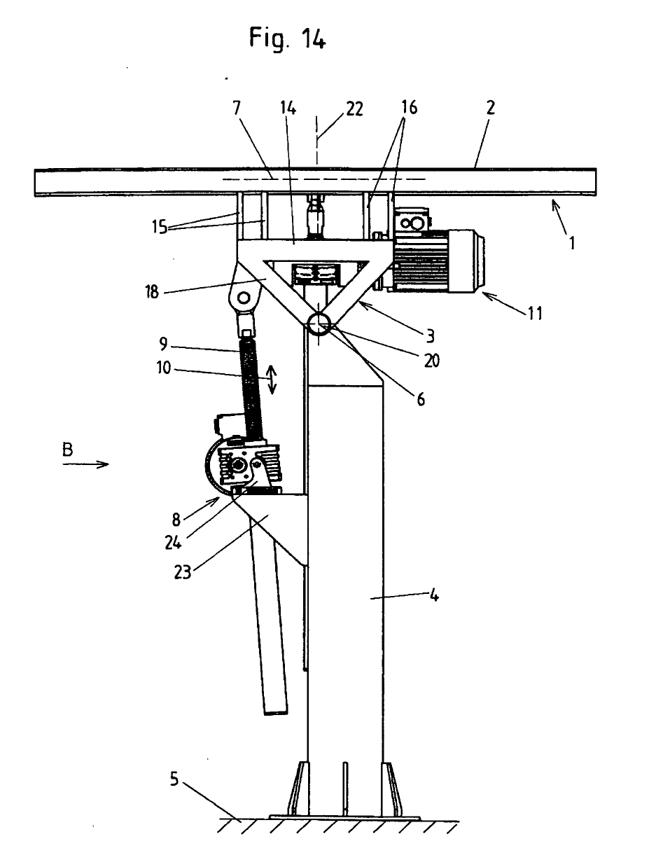

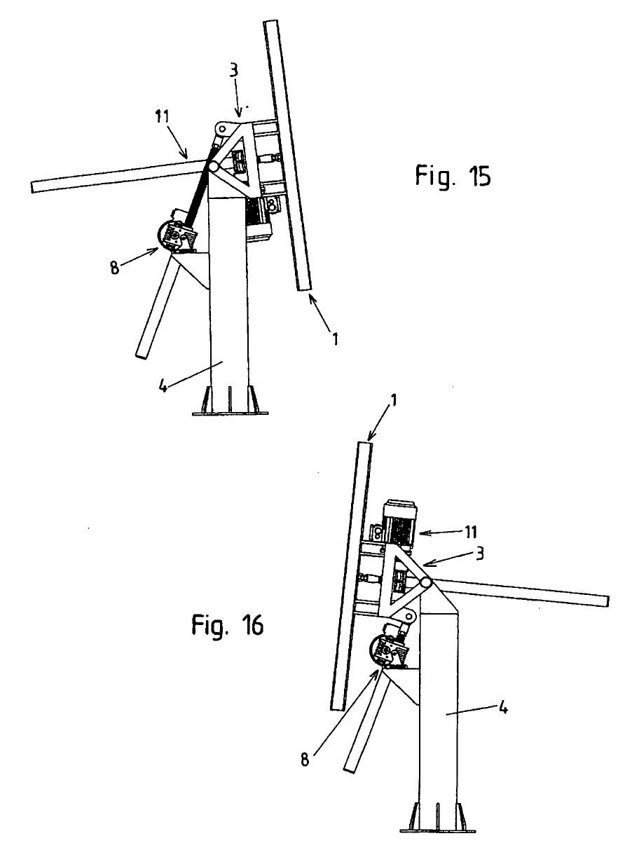

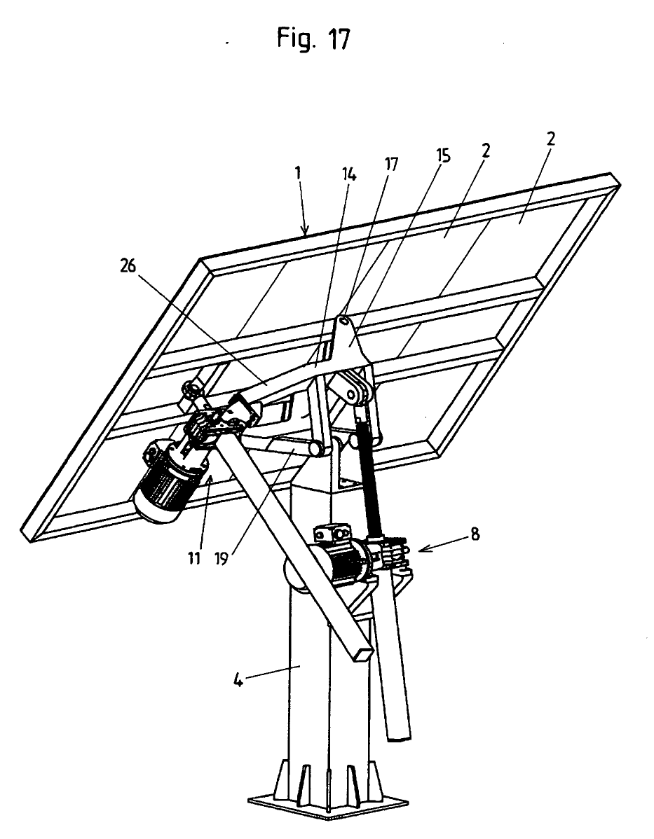

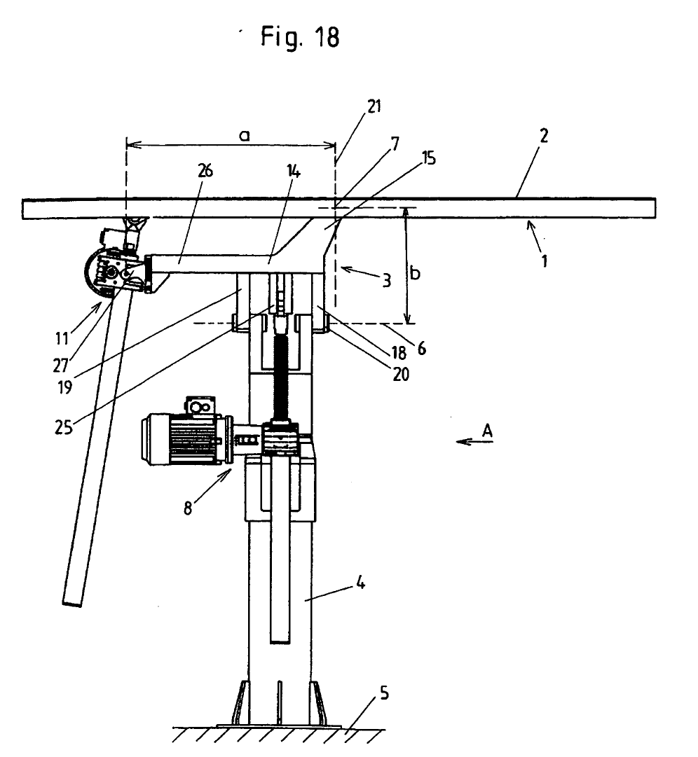

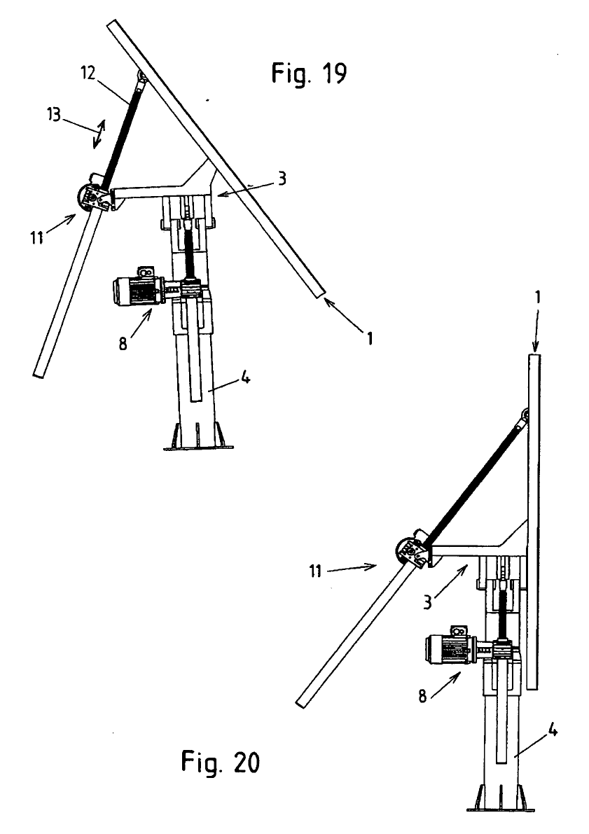

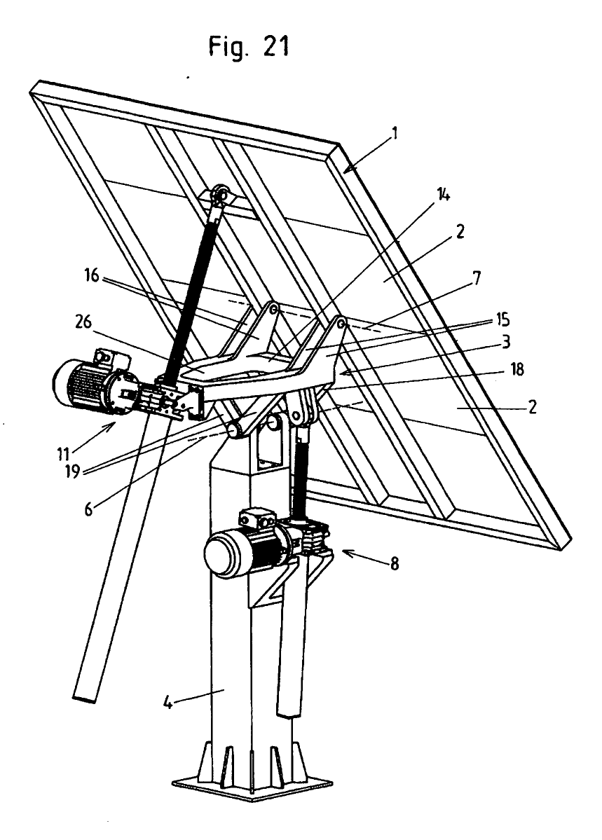

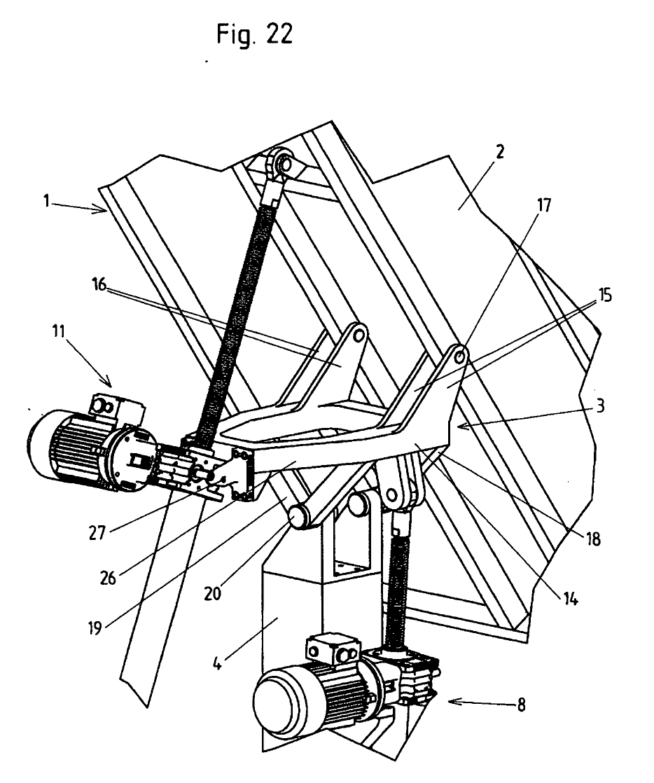

In the following, another exemplary embodiment of the invention is explained using FIGS. 12 through 22. For reasons of simplicity and clarity similar parts are marked with the same reference characters as before. This exemplary embodiment relates to a tracking device for adjusting the alignment of a support frame 1 to the position of the sun. Such tracking devices are particularly used in photovoltaic devices. Tracking devices of this type are also called “trackers.”

The support frame 1, which is aligned in reference to the position of the sun, preferably forms a contact plane, at which the elements supported abut, for example solar cell-modules 2, only schematically indicated in the figures. Using the tracking device, the contact plane of the support frame 1 and/or the planar elements abutting it can track the solar position. Here, preferably an alignment perpendicular to the solar radiation can occur over the entire path of the sun, beneficially at least over three-fourth of the path of the sun at its highest positions.

The support frame 1 is preferably embodied in an overall planar fashion, as illustrated.

For example, the support frame 1, as shown, can be embodied like a frame, having a support grid comprising several frame pieces positioned in the same plane.

For the rest, the embodiment is completely analogous to the above-described exemplary embodiment, with the identically embodied pivotal unit 3 here being connected on one side to the support frame 1, on the other side to the support 4. The pivotal unit 3 is identical, as illustrated above. The pivotal connection of the upper bearing sections 15, 16 to the support frame 1 occurs here directly at the support frame 1 (by openings in the frame legs of the support frame 1 penetrated by the respective bearing stud 17.) Mounting the bearing parts to the support frame 1 is also contemplated and possible.

Here, (instead of the vertical alignment of the axis 29 of the parabolic mirror) the support frame 1 and/or its contacting plane is horizontal in the normal position.

By simultaneously rotating the pivotal unit 3 around the lower axis 6 and the support frame 1 around the upper axis 7 the support frame 1 and/or its contact plane can track the position of the sun.

In both exemplary embodiments illustrated the support 4 may also be embodied differently than in the form of a towering stand.

### LEGEND FOR THE REFERENCE CHARACTERS

1 Parabolic mirror and/or support frame
2 Solar cell module
3 Pivotal unit
4 Support
5 Foundation
6 Lower axis
7 Upper axis
8 Lower actuator drive
9 Operating element
10 Direction of adjustment
11 Upper actuator drive
12 Operating element
13 Direction of adjustment
14 Base section
15 Upper bearing section
16 Upper bearing section
17 Bearing stud
18 Lower bearing section
19 Lower bearing section
20 Bearing stud
21 Plane
22 Plane
23 Console
24 Bearing block
25 Connector
26 Arm
27 Bearing part
28 Bearing part
29 Axis
30 Reflector
31 Opening

1. An adjustment device for aligning a unit (1), which receives and/or transmits and/or focuses radiation, comprising a support (4) for positioning the adjustment device upon a foundation, a pivotal unit (3), which in reference to the support (4) can be rotated around a horizontal lower axis (6) and, with said unit (1) to be aligned, can be rotated in reference thereto around an upper axis (7) positioned perpendicular in reference to the lower axis (6), the upper axis (7) is positioned horizontally in a neutral position of the pivotal unit (3) in reference to a rotation of the pivotal unit (3) around the lower axis (6), a lower actuator drive (8) for rotating the pivotal unit (3) in reference to the support (4) around the lower axis (6), and an upper actuator drive (11) for rotating the unit (1) to be aligned around the upper axis (7) in reference to the pivotal unit (3), with the pivotal unit (3) comprising a base section (14) and at least one upper bearing section (15, 16), projecting upwards therefrom in the neutral position of the pivotal unit (3) in reference to the rotation of the pivotal unit (3) around the lower axis (6), on the upper bearing section the unit (1) to be aligned is supported pivotally around the upper axis (7) and further comprises at least one lower bearing section (18, 19) projecting downwards from the base section (14) in the neutral position of the pivotal unit (3) in reference to the rotation of the pivotal unit (3) around the lower axis (6), at said lower bearing section the pivotal unit (3) is supported rotationally around the lower axis (6) in reference to the support (4).

2. An adjustment device according to claim 1, wherein the upper actuator drive (11), on the one side engaging the unit (1) to be aligned and, on the other side engaging a connecting point at the pivotal unit (3), which has a normal distance (a) from a plane (21) that includes the upper axis (7) and is aligned perpendicularly in reference to the lower axis (6), with the distance (a) amounting to at least half of a normal distance (b) between the lower axis (6) and the upper axis (7).

3. The adjustment device according to claim 2, wherein the connection point is arranged at an arm (26) of the pivotal unit (3) or at a bearing part (27) connected thereto in a fixed manner, with the arm (26) essentially projecting horizontally from that section of the base section (14), where at least one of the upper bearing sections (15, 16) and at least one of the lower bearing sections (18, 19) originate.

4. The adjustment device according to claim 1, wherein at least two of the upper bearing sections (15, 16) are provided, by which at least two separate pivot bearings are formed, spaced apart from each other in the direction of the upper axis (7).

5. An adjustment device according to claim 4, wherein a plane (22) comprising the lower axis and positioned perpendicular in reference to the upper axis is located between the two upper bearing sections (15, 16), or, if more than two of the upper bearing sections (15, 16) are provided, being positioned between the two outer ones of the upper bearing sections (15, 16).

6. The adjustment device according to claim 1, wherein at least two of the lower bearing sections (18, 19) are provided, by which at least two separate pivot bearings are formed spaced apart from each other in the direction of the lower axis (6).

7. The adjustment device according to claim 6, wherein a plane (21), comprising the upper axis (7) and positioned perpendicular in reference to the lower axis (6), is positioned laterally to the at least two lower bearing sections (18, 19).

8. The adjustment device according to claim 1, wherein the lower axis (6) is aligned in the north-south direction and the upper axis (7) is aligned in the east-west direction at the neutral position of the pivotal unit (3) with regard to the rotation around the lower axis (6).

9. The adjustment device according to claim 1, wherein the respectively upper bearing section (15, 16) diagonally projecting upwards in the neutral position in reference to the rotation of the pivotal unit (3) around the lower axis (6).

10. The adjustment device according to claim 1, wherein the respectively lower bearing section (18, 19) tapering downwards in reference to the neutral position of the rotation of the pivotal unit (3) around the lower axis (6).

11. The adjustment device according to claim 1, wherein the lower actuator drive (8), on the one side engages the support (4) or another part (23) connected thereto in a fixed manner, and on the other side engages a connecting part (23) that projects downwards in a neutral position in reference to the rotation of the pivotal unit (3) around the lower axis (6) of the pivotal unit (3).

12. The adjustment device according to claim 1, wherein the unit (1) to be aligned comprises a parabolic mirror or being formed by it.

13. The adjustment device according to claim 1, wherein the unit (1) to be aligned is a support frame for carrying elements (2) to be aligned in reference to a position of the sun.

14. The adjustment device according to claim 13, wherein the elements represent solar cell-modules to be aligned in reference to a position of the sun.
